(19) United States
(12) Patent Application Publication
(10) Pub. No.: US 2012/0130787 A1
(43) Pub. Date: May 24, 2012

(54) Multi-Purse Prepaid Consumer Discount Card Systems and Methods

(75) Inventors: Thomas Stouffer, Broomfield, CO (US); Scott Stouffer, Gaithersburg, MD (US); Bruce Olson, Vienna, VA (US)

(73) Assignee: Grodo, Inc.

(21) Appl. No.: 13/303,598

(22) Filed: Nov. 23, 2011

Related U.S. Application Data
(60) Provisional application No. 61/416,910, filed on Nov. 24, 2010.

(51) Int. Cl. G06Q 30/02

(52) U.S. Cl. 705/14.17; 705/14.1; 705/14.38

(57) ABSTRACT

Disclosed herein are systems and methods for providing a multi-purse consumer discount card. The systems and methods may use transaction data to provide one or more negotiated discount rates to a consumer. For example, an amount may be credited to a consumer's purse for a merchant based on that consumer's transaction volume for that merchant.

### RELATED APPLICATIONS

This application claims priority to U.S. Provisional Patent Application No. 61/416,910, filed on Nov. 24, 2010, the contents of which are incorporated into this application.

### FIELD

This application is directed towards methods and systems for providing services to consumers or merchants. For example, it includes embodiments where a multi-purse discount card is provided to a consumer.

### BACKGROUND

Merchants use a number of tactics to entice consumer's to purchase goods from them. For example, some merchants employ customer rewards programs, such as loyalty cards. The consumer may receive, for example, a coupon for an amount of a next purchase. The problem with loyalty cards, however, is that a consumer often has a loyalty card for each merchant. A consumer also often carries many forms of payment, such as credit or debit cards.

Accordingly, there is a need for a multi-purse consumer discount card, as described in more detail below.

### SUMMARY

Embodiments that are consistent with this disclosure may take numerous forms. For example, a computer-implemented method for providing a prepaid multi-purse consumer discount card to a user is disclosed. The method may comprise loading, by a load engine, a set of subaccounts corresponding to a single user account with prepaid user-provided funds and non-user-provided prepaid discount funds, one or more of the subaccounts being associated with one or more merchants. The method may further comprise receiving, by a processing platform, a data element comprising transaction data associated with a transaction for the user, the transaction data comprising a transaction amount, discount card data, and merchant identification data. The method may further comprise determining, by a processing engine, whether the transaction is approved by comparing the transaction data to information stored in an authorization table. The method may further comprise, when it is determined that the transaction is approved, sending an approval message to the merchant of the one or more merchants that is associated with that transaction that allows the user to obtain a discount on the transaction by using the user-provided funds to satisfy a first portion of the transaction. The method may further comprise settling, by a settlement engine, a second portion of the transaction with the merchant based on the negotiated prepaid discount on an applicable transaction volume.

### BRIEF DESCRIPTION OF THE DRAWINGS

FIG. 1 is an exemplary multi-purse prepaid consumer discount card, consistent with embodiments of the present invention.

FIG. 2 is a block diagram of an exemplary system architecture for providing and using a multi-purse prepaid consumer discount card, consistent with embodiments of the present invention.

FIGS. 3A and 3B depict exemplary processes, consistent with embodiments of the present invention.

FIGS. 4A and 4B depict exemplary processes for loading a multi-purse prepaid consumer discount card, consistent with embodiments of the present invention.

FIGS. 5A and 5B depict exemplary processes for processing transaction data generated by use of a multi-purse prepaid consumer discount card, consistent with embodiments of the present invention.

FIG. 6 depicts an exemplary process for settling transactions with merchants and receiving merchant discount rebates, consistent with embodiments of the present invention.

FIG. 7 depicts an exemplary contents of tables employed in an embodiment, consistent with embodiments of the present invention.

### DETAILED DESCRIPTION

Consumers love discounts and awards. Accordingly, merchants often employ discount and/or award programs to entice potential customers to choose their product or service over alternatives. In some embodiments, systems and methods of providing a consolidated discount and/or award programs are disclosed. Consolidated discount and/or award programs may have one or more merchant partners that participate in the program. These programs may use one or more multi-purse prepaid consumer discount cards. The cards may be a physical card, an application, an account number or other identifier, etc. The card may include or be linked to one or more purses. A purse may be any manner of storing funds, such as an account or subaccount. The purse may be prepaid. For example, a portion of the funds may have been credited to a purse prior to a consumer using the purse for a transaction. There programs may be run by a group of merchant partners operating under some type of collaborative agreement or who have subscribed to one or more discount and/or award programs.

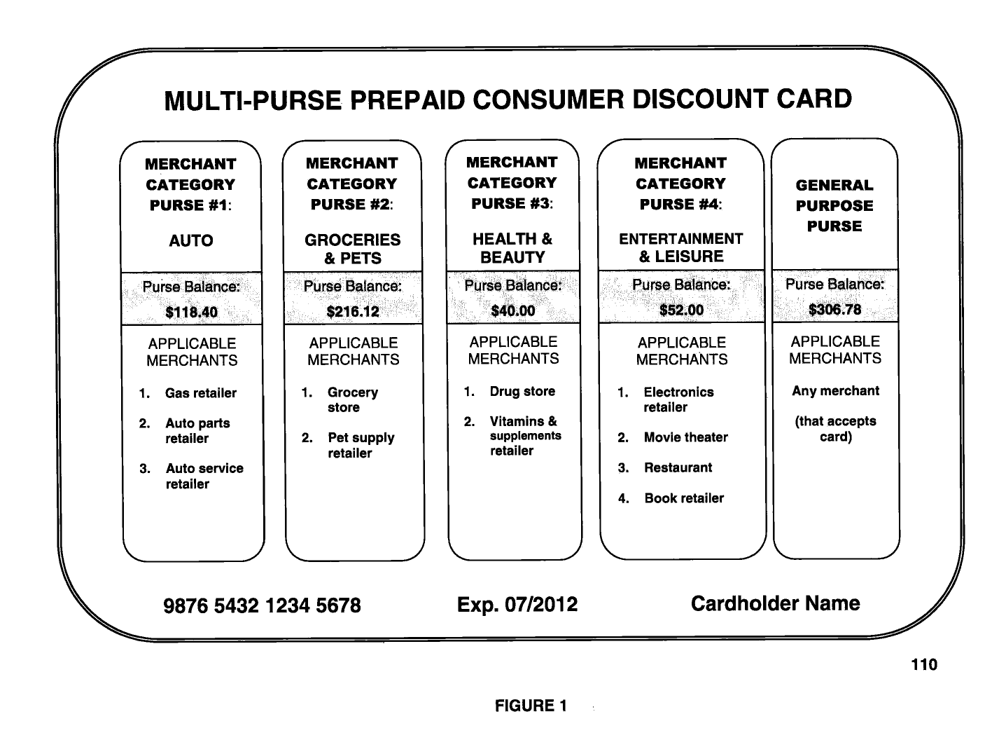

FIG. 1 is an example of a multi-purse prepaid consumer discount card 110 showing a single card that may be employed by a user. The card may consolidate prepaid balances for a user across several merchant categories and/or a general-purpose purse. For example, in FIG. 1 a user has purses in four categories such as auto, grocery and pets, health and beauty, and entertainment and leisure. There may also be one or more merchant partners associated with each category. Transactions made at merchant partners in any of the merchant categories may be sold to the user at a discounted price. This may be done by providing a discount at the time of the purchase or by refunding a portion of the purchase price. Transactions may also be made at merchants that are not partners by using funds from the general-purpose purse. The general-purpose purse may also permit seamless-split tender transactions at merchant partners where the balance in the general-purpose purse may be combined with the balance in the relevant merchant category purse to cover the full transaction amount if it exceeds the merchant category purse balance. For example, in FIG. 1, if the balance under the auto category is exceeded, funds may be drawn for the general-purpose purse.

Although not depicted on FIG. 1, the card may support credit and/or debit capabilities. This may allow the user to seamlessly complete a purchase transaction that exceeds the user's prepaid balances by applying the excess balance to the user's credit or debit account. The term “credit facility” or “debit facility” is used herein to describe any method for providing the user credit or debit capabilities associated with prepaid consumer discount card 110. One method for providing credit or debit facilities may be to link consumer discount card 110 to existing, externally administered credit accounts or debit accounts of the user. A different method may involve providing an integral credit account or debit account administered as a part of the discount card program.

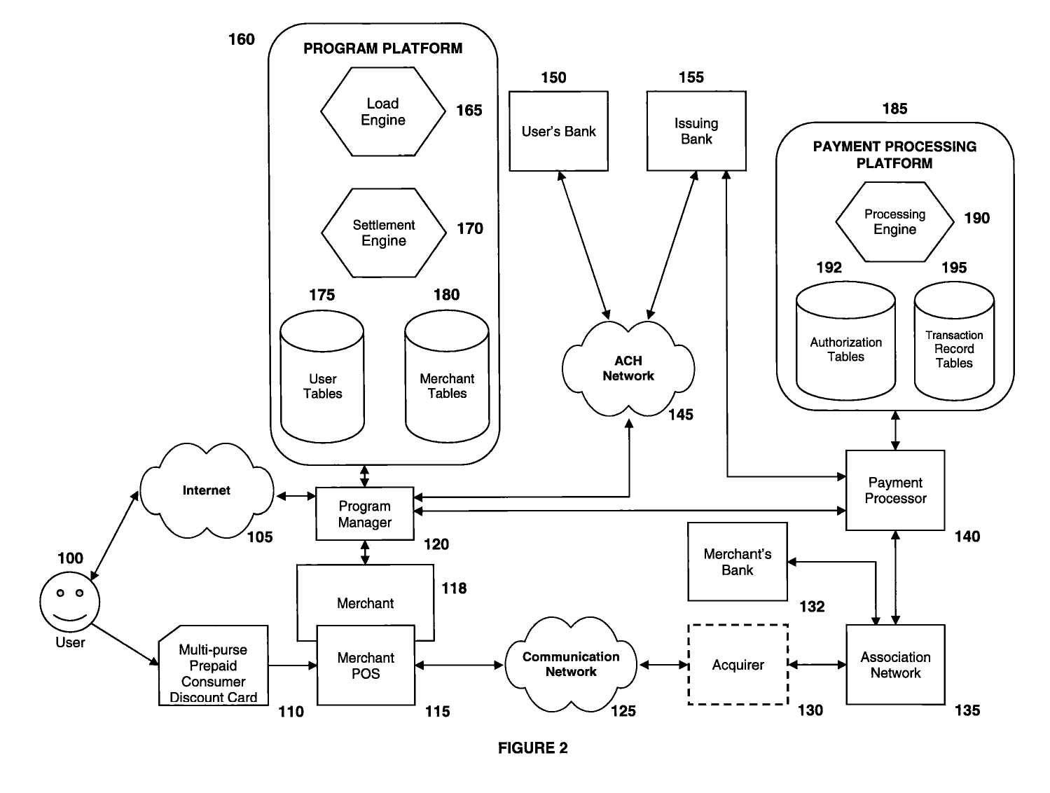

FIG. 2 is a block diagram depicting an exemplary system architecture for providing a multi-purse prepaid consumer discount card, consistent with embodiments of the present invention. The system architecture may include a user 100 having a multi-purse prepaid consumer discount card 110. The user may be a consumer or entity, such as a business, that holds a financial account for the multi-purse prepaid consumer discount card. The card 110 may correspond to an account enabling the user to transfer funds of user-determined amounts into various “purses” (e.g., financial accounts or sub-accounts) associated with the card. Each purse (other than a general-purpose purse) may be associated with a group of merchant partners 118 that may be organized into merchant categories. These user-provided funds may be available to the user to be spent at the merchants 118. In addition to the user-provided funds, for example, and as a reward for the prepayment of those funds, users may receive varying amounts of additional funds added to merchant category purses that are not user-provided, thereby increasing the user's purchasing power beyond the extent of the funds provided by the user. Effectively, the user may receive a discount albeit instead of a discount off the purchase price, the user receives more dollars to spend than the user originally provided.

The user 100 may employ the multi-purse prepaid consumer discount card 110 or the card account number at a merchant point of sale (POS) 115 to make a purchase transaction. The merchant POS 115 may be a method or device for capturing information about the transaction including card account number, merchant identifier, and transaction amount. A “transaction” or “purchase transaction” as used herein may include the common types of consumer financial transactions with a merchant, such as purchases and returns.

The merchant POS 115 may communicate with an association network 135 via a communication network 125 (e.g., a telecommunication or computer network, such as a LAN, WAN, or the Internet). There may or may not be an acquirer 130 acting as an intermediary between the merchant POS and the association network. An acquirer, when present, may act as an aggregator of communication requests between numerous merchant POS devices and the association network.

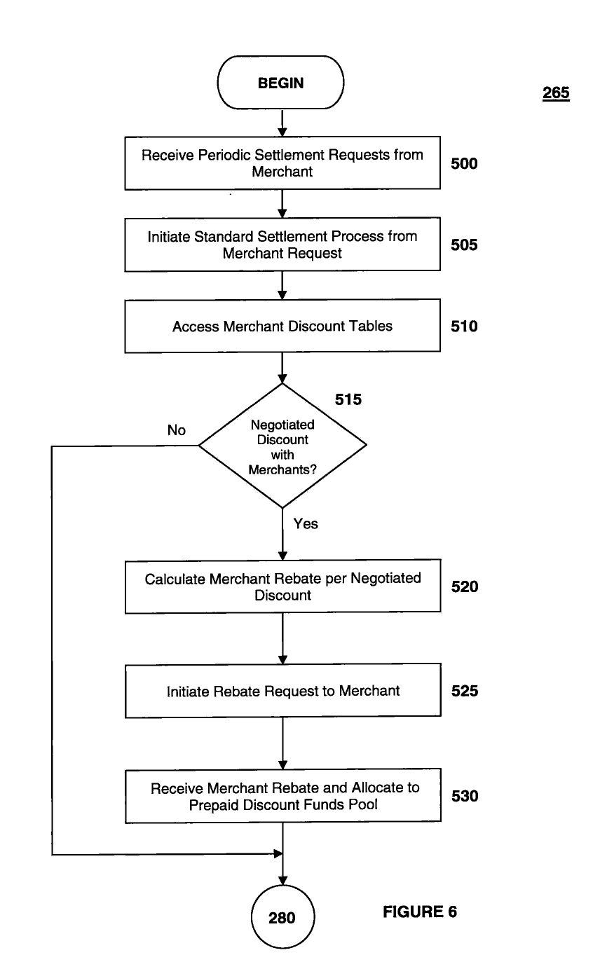

The merchant's bank 132 may communicate with the association network 135 and/or the issuing bank 155 to fulfill the transaction settlement process. As detailed in FIG. 6, the merchant's bank may initiate periodic requests through the association network 135 to the issuing bank 155 resulting in funds transfer to the merchant's bank 132 in settlement of outstanding transactions. The merchant's bank 132 may transfer merchant discount rebate funds to the program manager 120 and/or the issuing bank 155.

The association network 135 may be a network associated with the card issuer (e.g., Visa, MasterCard, American Express, Discover). The association network 135 may communicate with the payment processor 140 and the payment processing platform 185. In certain embodiments, each time the card 110 is used, a transaction authorization request may flow from the merchant POS 115 to the payment processing platform 185 where the processing engine 190 determines if the transaction should be authorized or declined. The processing engine 190 may then initiate a message back to the merchant POS 115 indicating the authorization status of the transaction. Another embodiment may employ a closed-loop network whereby an association network 135 may not be present. In a closed-loop network embodiment, a communication for the purposes of transaction authorization and/or transaction settlement may be accomplished by means other than the association network.

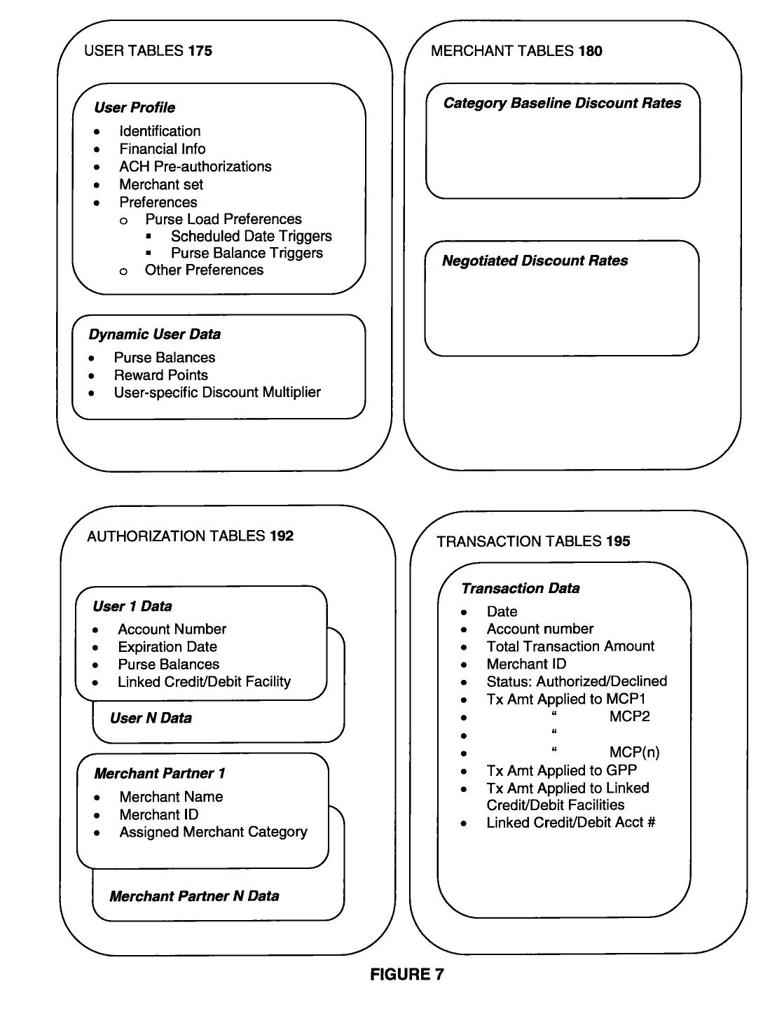

To establish an account, load the card, check the balances on the card, or to initiate other actions, the user 100 may access, via the network 105, a website managed by the program manager 120. Functions and information provided by the website may interact with the program platform 160. When the user registers and establishes an account, various information related to the user may be stored in a user profile in the user tables 175. FIG. 7 illustrates that user tables may include a user profile and dynamic user data. The user profile may include the identification of the user and financial information, ACH pre-authorizations and/or various user preferences. The user preferences may include purse load preferences (e.g., scheduled date triggers, purse balance triggers) as well as other preferences. The dynamic user data may include purse balances, user reward points, user-specific discount multipliers, etc.

When the program manager 120 adds a new merchant 118 to the program, information associated with that merchant may be stored in the merchant tables 180. As illustrated in FIG. 7, merchant tables 180 may include category baseline discount rates, negotiated discount rates, etc. The load engine 165 may use data in the user tables 175 and/or the merchant tables 180 along with input from the user via the website to determine the amounts of money to be loaded in the various purses on the card.

In certain embodiments, funds provided by the user to load the card may be transferred from the user's bank 150 to the issuing bank 155 via the automated clearing house (ACH) network 145. As the result of a card-load event, the program manager 120 may request the issuing bank to originate an ACH transfer of the user-provided funds from the user's bank. While not depicted in FIG. 2, in another embodiment, the user's bank and the issuing bank may be the same entity. In another embodiment, a local bank may offer the multi-purse prepaid consumer discount card to its customers with an associated debit facility, in other words, the card would act both as the bank's standard debit card and also as the prepaid discount card.

The payment processing platform 185 may use data stored in the authorization tables 192 along with other data to approve or decline each transaction. The payment processing platform may also save data from all transactions, whether authorized or declined, in the transaction record tables 195. As illustrated in FIG. 7, transaction data may include date, account number, total transaction amount, merchant ID, authorization status, transaction amounts applied to each purse and/or credit or debit facility, etc. The data in these tables may be periodically sent from the payment processor 140 to the program manager 120 and may be used in the transaction settlement process. The settlement engine 170 may use this data along with data stored in the merchant tables 180 to determine the amount of the merchant discount rebate that may be due to the program manager from each merchant.

As described in further detail below, user tables 175 may contain the user's profile, preference information, and reward points data along with other user-specific information, while merchant tables 180 may contain the merchant category cross-reference tables, the merchant discount tables showing the negotiated discount with each merchant, and the category baseline discount tables with the nominal prepaid discount funds rates for each merchant category.

The program manager 120 may administer a reward points program based on various components of user participation in the card program such as the total number or value of purchase transactions executed using the card or the number of referrals for additional card users made by a given user. The system architecture depicted in FIG. 2 may be considered an open-loop network architecture meaning that the consumer discount card is accepted at any merchant participating in an association network (e.g., Visa, MasterCard, American Express, Discover). Another embodiment may use a closed-loop network system architecture whereby the card may be accepted at a restricted set of merchants. In such an embodiment, certain methods (e.g., transaction processing, settlement) may not involve an association network 135.

While FIG. 2 depicts functions or components in particular locations, they may be rearranged or combined without departing from the scope of this disclosure. For example, the user's bank 150 and the issuing bank 155 may be the same entity. Similarly, the program manager 120 and associated program platform 160 may be provided by the same entity that provides the payment processor 140 and/or payment processing platform 185. These different embodiments provide deployment flexibility across multiple scenarios. One scenario may be an Internet-based savings club where consumers join the club in order to get access to unique savings opportunities from merchants associated with the club. Another scenario may be as a strategy extension for local deal-of-the-day Internet sites that would offer users a perpetual savings opportunity from a select set of merchants in non-discretionary commerce categories, supplementing the ad hoc opportunities currently provided by these sites for discretionary purchases. A third scenario may include personal financial management e.g., personal budgeting software that includes a special budgeting feature providing accelerated savings opportunities for the users of the software. A fourth scenario may be deployment by banks as a value-added payment card for customers, providing customers with unique savings opportunities at a select set of merchants while at the same time providing the banks with increased revenue and deposit opportunities. In another scenario, there may be a combination of one or more of the aforementioned scenarios.

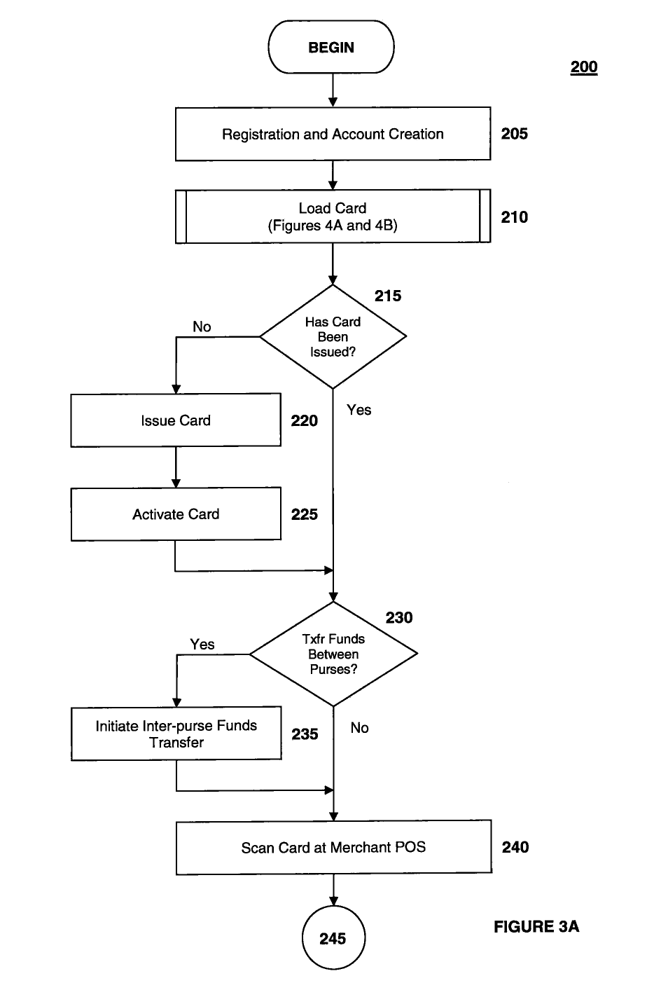

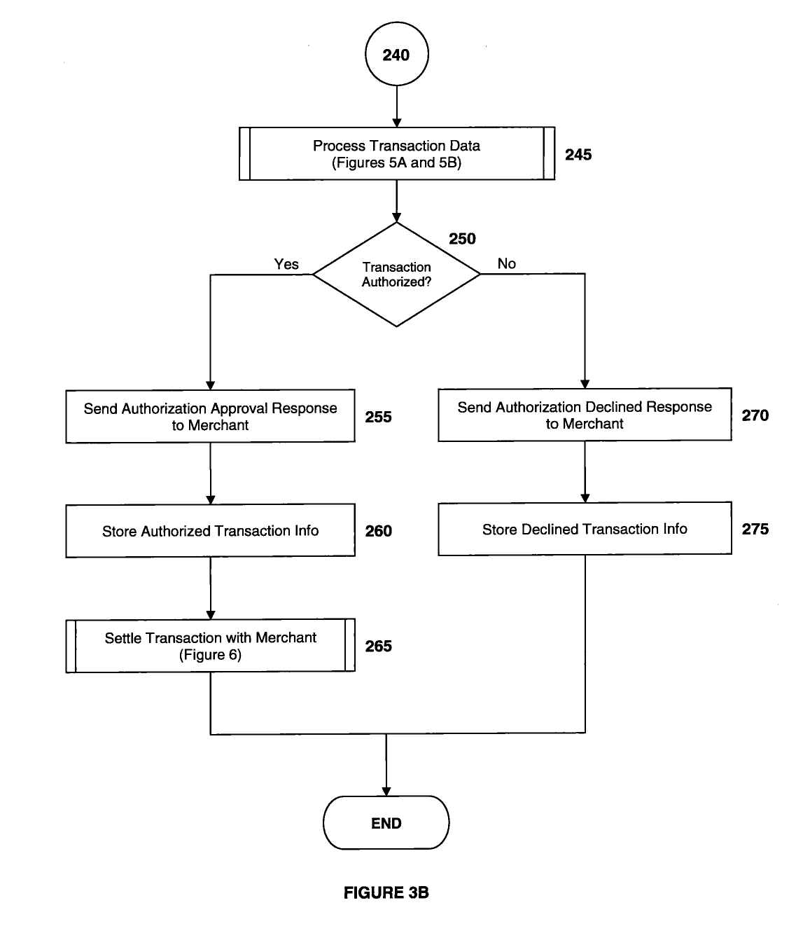

FIGS. 3A and FIG. 3B depict an exemplary method 200 for providing and using a multi-purse prepaid consumer discount card 110 as shown in FIG. 2.

At step 205, a user 100 may access, via the network 105, a website maintained by the program manager 120 that allows the user to register and create an account. The user may provide identification, address, financial and preference information (e.g., the user profile) that may be stored in the user tables 175. The user information may then be sent by the program manager 120 to the payment processor 140 to initiate creation of a new user account. The payment processor in turn may notify the issuing bank 155 to create a new account. In certain embodiments, no configuration or customization of the merchant POS or payment processing network may be required during registration and account creation because existing processes may be used without modification.

As part of the registration process in step 205, the program manager 120 may employ the user's address information to look up the designated set of merchant partners for the specified geographic region. For each merchant category, the designated set of merchant partners may vary by the geographic unit on which the program is administered. A given user's designated set of merchant partners may be stored in the user's profile.

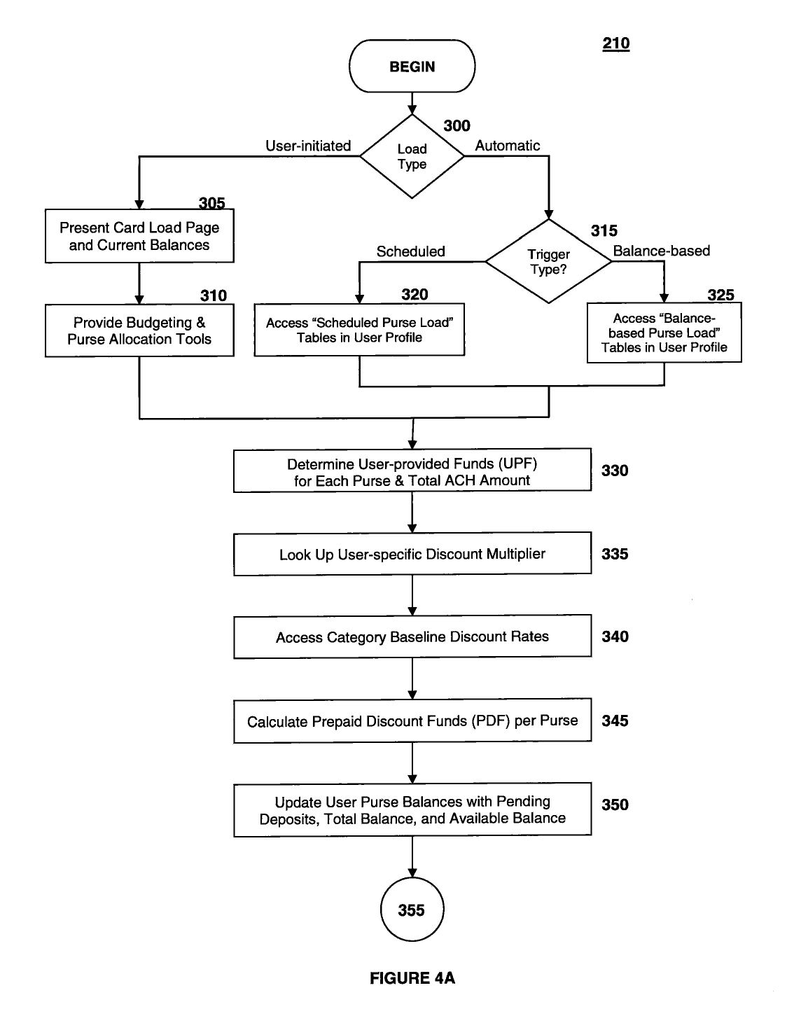

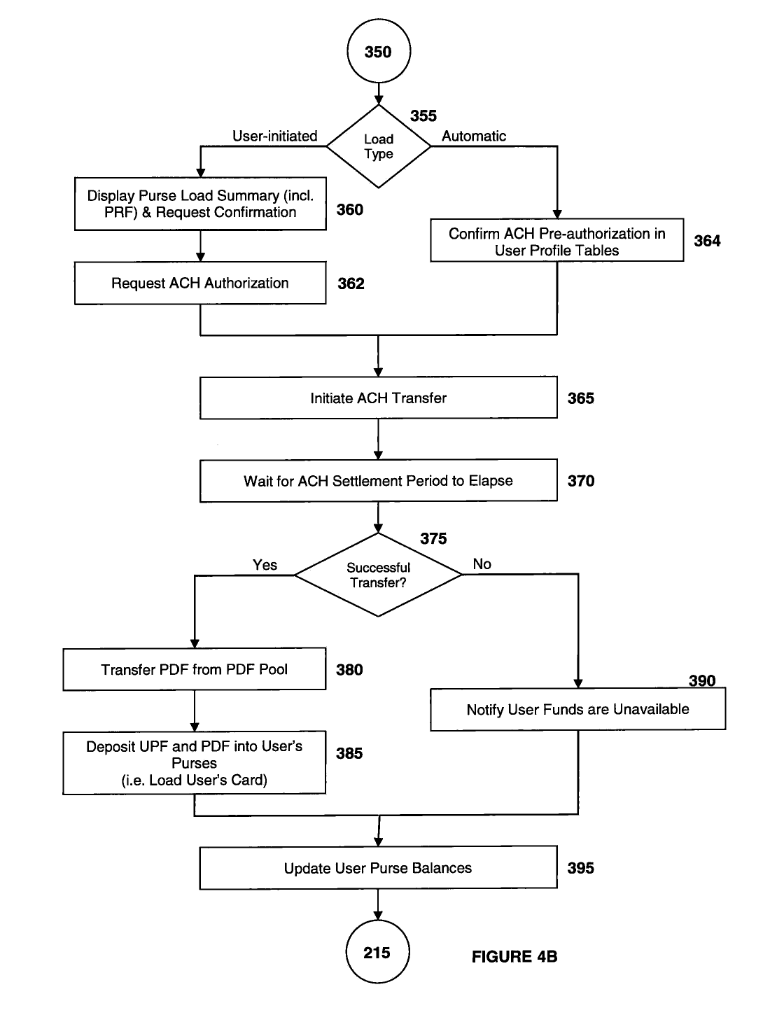

Following registration and account creation, a user 100 may load the card 110 as depicted in step 210. Different embodiments may allow for various methods of loading funds to the card, as described below in FIGS. 4A and 4B. Examples of two types of card load events include: 1) user-initiated loading and 2) automatic loading. In either case, the source of user funds may be an existing financial account when the user has opted to make payment via ACH transfer. While FIG. 4B depicts user payment via ACH transfer, other methods of user payment may be used. For other such payment methods, the source of user funds may be something other than an existing financial account.

The initial card load may be initiated by the user immediately following account creation. The user may specify how much money is to be loaded to the general-purpose purse (GPP) and to each merchant category purse (MCP) using tools provided by the load engine 165. Card loads may also be initiated automatically on a scheduled or balance-based trigger as determined by information entered by the user into their user profile. User payment may be accomplished via an automated clearing house (ACH) transfer from the user's bank 150 covering the total amount of the user-provided prepaid funds (UPF). In addition to the UPF, the user may receive additional funds, called the prepaid discount funds (PDF), that are not funded by the user. FIGS. 4A and 4B provide additional detail on the card load process.

At step 215, a determination may be made whether the card load was the initial load of the card prior to card issuance or whether a re-load of the card. The first time the card has been loaded with funds (step 215, No), the program manager 120 may notify the payment processor 140 to issue the card in step 220. A card activation process may follow in step 225. If this is a card re-load event (sep 215, Yes), the method may proceed to step 230.

At step 230, the method 200 may provide an opportunity for the user 100 to transfer funds between purses on the card 110. If the user chooses not to transfer funds between purses (step 230, No), the method may proceed to step 240. If the user does choose to transfer funds between purses (step 230, Yes), the method 200 may proceed to step 235 where the user is presented with a webpage via the Internet 105 that shows current purse balances and options to transfer funds between the purses. The user may select the amounts to be transferred between designated purses. The method provides the option of restricting the amounts applicable for transfer based on a variety of criteria such as the discount rates applied to the various purses involved in the transfer or pending transactions from a given purse that have not been settled. When the desired transfers have been selected by the user, the program manager 120 may update the user purse balances. Then, the program manager 120 may send a request to the payment processor 140 to update the authorization tables 192 accordingly. The method may then proceed to step 240.

At step 240, the multi-purse prepaid consumer discount card 110 may be scanned at the merchant point of sale 115 during a transaction. Information associated with the merchant such as a merchant identifier may be captured along with the other transaction data (e.g. transaction amount, user account number). The information may flow through the payment network as described in FIG. 2 to the payment processing platform 185 for analysis. While this step may be accomplished by physically scanning the card, the method also allows for the card account number and transaction information to be manually entered at the merchant POS. In another embodiment, the information may be transmitted from the card to the POS. The card does not necessarily have to be a physical card but may simply be an account number or an application running on a device.

At step 245, the transaction data received by the payment processing platform 185 may be processed by the processing engine 190 using the authorization tables 192. As illustrated in FIG. 7, the authorization tables may include user data for each user, merchant data for each merchant partner, etc. The user data may include account number, expiration data, purse balances, information on credit or debit facilities, etc. Merchant partner data may include merchant name, merchant ID, assigned merchant category, etc. The processing engine 190 may compare transaction amount and merchant identifier against purse balance information stored in the authorization tables 192 to determine whether a transaction is approved or declined.

If the processing engine 190 determines the transaction should be authorized (step 250, Yes), the payment processing platform 185 may send an approval message to the merchant point of sale 115 allowing completion of the transaction (step 255). At step 260, the processing engine 190 may save the transaction data associated with the authorized transaction to the appropriate merchant file in the transaction record tables 195 (e.g. those shown FIG. 7). For each authorized transaction, the processing engine may record data indicating how much of the transaction amount was paid by funds in the merchant category purse, the general-purpose purse, any credit or debit facility, or a combination thereof. The payment processing platform 185 may periodically (e.g. daily or weekly) send the information in the transaction record tables 195 to the program manager 120.

At step 265, all approved transactions for a merchant may be settled. In certain embodiments, the settlement process may consist of two phases: a standard settlement process through the association network 135 involving the issuing bank 155 and acquiring (e.g. merchant) bank 132 as well as a second phase between the program manager 120 and merchant 118 whereby the merchant rebates to the program manager an amount calculated based on the negotiated discount and transaction volume with that merchant.

Referring back to step 250, if the processing engine 190 determines the transaction should be declined (step 250, No), the payment processing platform 185 may send a declined message to the merchant point of sale 115 which precludes completion of the transaction (step 270). At step 275, the processing engine 190 may save the transaction data associated with the declined transaction to the transaction record tables 195.

FIGS. 4A and FIG. 4B depict an exemplary method 210 for loading funds on the multi-purse prepaid consumer discount card. The card may be loaded via user-initiated action or automatically. At step 300, the system (e.g., program manager 120) may determine whether the card will be loaded by the user 100 or automatically, e.g., by the program platform 160. User-initiated loads may result from direct user interaction with a webpage provided by the program manager 120 via the Internet 105. This interaction can be accomplished from a variety of web-connected devices including PCs, tablets, mobile phones, etc. Automatic loads may be initiated, for example, by the program platform 160 when the load engine 165 detects a load trigger condition as set in the user preferences stored in the user tables 175.

If the user 100 has initiated the card load (step 300, user-initiated), the user may be presented via the Internet 105 with a webpage showing current purse balances on the user's card in step 305. In some embodiments, the system may provide budgeting and purse allocation tools in step 310. At step 330, the user may employ these tools to determine of how much money the user wishes to load into each purse on the card. The total amount to be loaded by the user across all purses may represent the amount to be transferred from the user's bank 150 via ACH 145 to the issuing bank 155.

Referring back to step 300, in the case of an automatic card load event (step 300, automatic), the system may determine the trigger type (step 315). Automatic card loads may be initiated via a “scheduled” trigger or a “balance-based” trigger, for example. For a “scheduled” trigger, the method may proceed to step 320 and access scheduled purse load preferences in the user profile stored in the user tables 175. For a “balance-based” trigger, the method may proceed to step 325 to access balance-based purse load preferences in the user profile. In either case, at step 330 the load engine 165 may determine the amount of funds to be added to which purses per the requirements defined by the respective purse load preferences.

At this point, the amount of user-provided funds (UPFs) to be loaded onto the card have been determined. The card may also be loaded with additional prepaid discount funds (PDFs) which are not funded by the user 100. The PDFs may increase the purchasing power of the user in each merchant category, in effect, giving the user a “discount.” The PDFs may be determined, for example, based on discount multipliers specific to each user, on category baseline discount rates specific to each merchant category, etc.

At step 335, the load engine 165 may look up the user-specific discount multiplier in the user tables 175. The user-specific discount multiplier may be generated by the program manager 120 based on the user's reward points, also stored in the user tables 175. The program manager 120 may administer the reward points program based on a number of criteria that define program participation. These criteria may change over time but can include such things as overall monthly card transaction volume, transaction history across categories, user recruitment, and participation in standalone program promotional events. The reward points program may offer users an opportunity to increase the level of prepaid discount funds they receive beyond the default level awarded to all users of the multi-purse prepaid consumer discount card.

At step 340, the load engine 165 may access category baseline discount rates in the merchant tables 180 that contain data defining, for each merchant category, the nominal category discount rate to be used in the calculation of the PDF for each merchant category purse. For example, a category involving auto related merchants might have a nominal category discount rate of 10% assigned to it.

At step 345, the load engine 165 may use the user-specific discount multiplier, the category baseline discount rates, the amount of UPFs allocated by the user 100 to each merchant category purse, etc. to calculate the amount of PDFs to be added to each of the user's merchant category purses on the card. For example, a user with a user-specific discount multiplier equal to 1.2 may wish to load $100 into a category purse involving auto related merchants with a category baseline discount equal to 10%. In this case, the PDF would equal the product of the user-specific discount multiplier, the $100 UPF and the 10% category baseline discount, or $12.

At step 350, the load engine 165 may update the pending balance information in the user tables 175. Pending deposits (e.g. UPFs and PDFs) may be added to the currently “available balances” to create the “total balances.” For example, if a user's available balance in the auto category purse was $32 and that user loaded an addition $100 of UPF into that purse which corresponded to an additional $12 in PDF, then that user's total balance for the auto category purse would then become $144.

At step 355, the load engine may initiate the user payment process. For a user-initiated card load, the method may proceed to step 360 and may display to the user a purse load summary webpage indicating the UPF and PDF amounts to be deposited to each of the card purses. Confirmation may be requested from the user for the pending load transaction as shown in the summary. If the user rejects confirmation, the method may return to step 305 (not shown).

If the user accepts the pending load transaction, the method may proceed to step 362 and the load engine 165 may request authorization from the user to initiate the ACH transfer from the user's bank 150 account for the amount determined in step 330. If the user does not authorize the ACH transfer, the pending load transaction may be cancelled and the user may be returned to step 305 (not shown). If the user does authorize the ACH transfer, the method may proceed to step 365.

Referring back to step 355, for automatic card loads, the method may proceed to step 364 where the load engine 165 confirms that the user tables 175 contain a valid ACH pre-authorization and then proceeds to step 365. At this point, the total amount of UPF has been determined and an ACH transfer for that amount has been authorized. The ACH transfer may then be initiated in step 365. The program manager 120 may send an ACH initiation message to the issuing bank 155 which then originates the ACH transfer with the user's bank 150 via the ACH network 145. While FIG. 4B depicts user payment via ACH transfer, other methods of user payment may be used. Also note that in embodiments where the issuing bank and user's bank are the same entity, user payment may not be executed using the ACH network but rather executed internally by the bank using another method. At step 370, the method may incorporate a pre-defined ACH settlement period which is allowed to elapse in order to reduce the risk of ACH returns.

At step 375, if no ACH returns have occurred during the ACH settlement period, the ACH transfer may be considered successful and the method proceeds to step 380. At this point in the process, the UPF may have been received from the user's bank 150 but those funds and the associated PDF have not been made available to the user yet.

At step 380, the prepaid discount funds may be transferred from the PDF pool and both the UPF and PDF are then deposited to the user's card purses in step 385. The prepaid discount funds pool may be a distinct set of funds, not provided by users, for which the program manager 120 is responsible. Funding of the PDF pool may come from a variety of secondary sources (e.g. non-users), most notably the merchant discount rebates. The net effect may be to take the aggregate merchant discount rebates received by the program manager into the PDF pool and disaggregate them back to the users through the prepaid discount funds. While FIG. 4B depicts the prepaid discount funds being transferred from the PDF pool to the user's card purses during the card load process, the timing of the actual transfer of prepaid discount funds may occur coincident with the settlement process rather than the card load process.

At step 395, the load engine 165 may update the user purse balances in the user tables 175 to reflect that the load transaction has completed and the pending deposits have become “available” balances. At this point, all the money may be available to the user for purchase transactions. For example, “total” balances may be equal to “available” balances.

If the ACH transfer is not successful due to an ACH return or some other issue (step 375, No), the user may be notified that the ACH transfer was unsuccessful, and neither the UPF nor PDF associated with the present card load event are available to the user (step 390). The load engine 165 may update the user purse balances in the user tables 175 to reflect that the load transaction has failed. The “total” and “available” purse balances may revert back to their state prior to initiation of the card load.

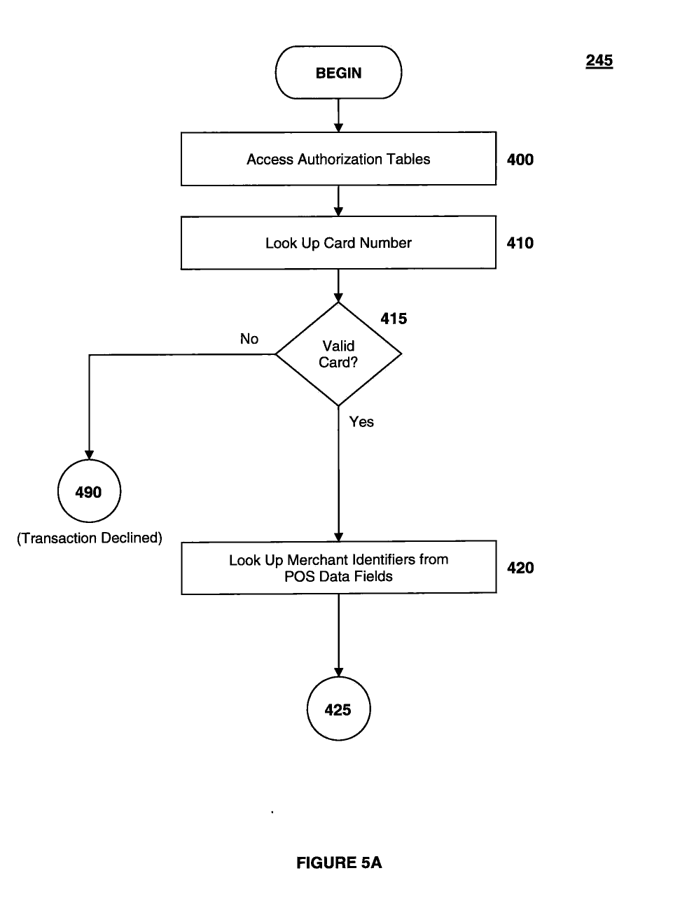

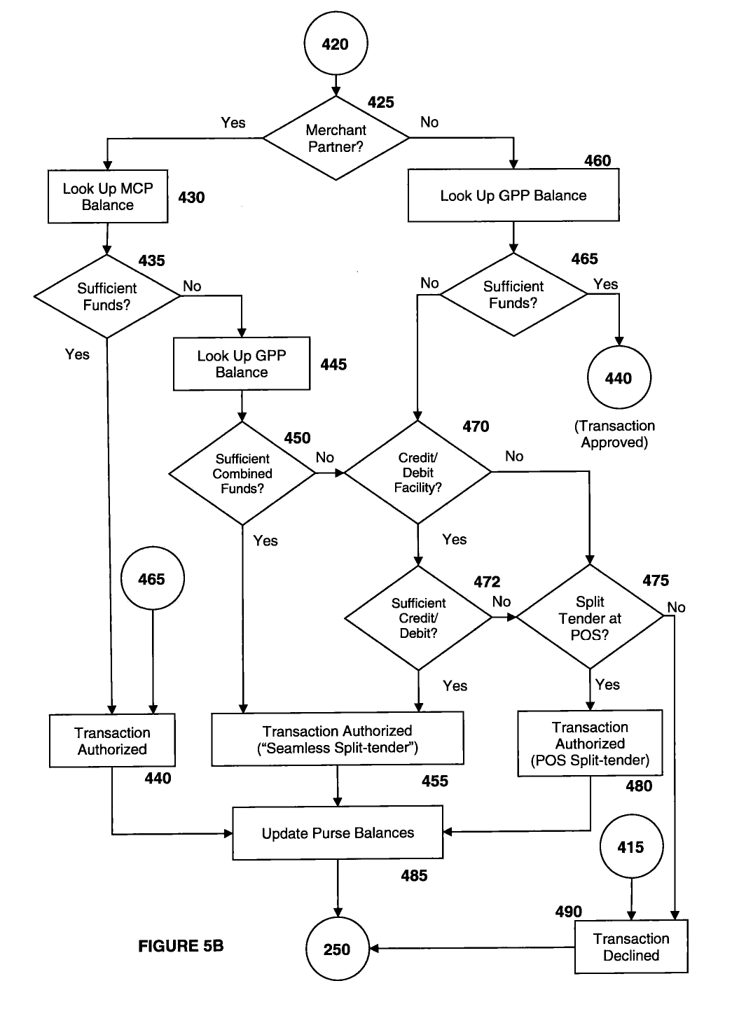

FIGS. 5A and FIG. 5B are detailed process flow diagrams depicting an exemplary method 245 for processing transaction data derived from using the multi-purse prepaid consumer discount card.

At step 400, the processing engine 190 may access the authorization tables 192. The authorization tables may store information related to the user account numbers and purse balances, user credit and debit facilities (if any), merchant partners and their associated merchant category, and any other information required to process transaction approvals or rejections. At step 410, the processing engine 190 may look up the card account number received in the transaction data from the merchant POS 115. At step 415, the processing engine 190 may determine whether the card is valid. Card validity may be based on a number of factors (e.g., active account number, expiration date, etc.). If the card is invalid, transaction is declined (step 490). If the card is valid, the processing engine 190 looks up the merchant identifier fields from the POS transaction data (step 420).

At step 425, the processing engine may check the authorization tables 192 to see if the indicated merchant is a program partner. If so, at step 430 the processing engine 190 may determine which merchant category purse the indicated merchant is assigned to and look up the current balance for that merchant category purse in the authorization tables 192. At step 435, the method may determine if there are sufficient funds in that purse to cover the transaction amount received in the POS transaction data. If so, the transaction is authorized (step 440).

Referring back to step 435, if a determination is made that the merchant category purse does not contain sufficient funds to cover the transaction amount, the processing engine 190 may look up the current balance of the general-purpose purse in the authorization tables 192 (step 445). At step 450, the processing engine 190 may determine whether the combined balance of the merchant category purse and the general-purpose purse are sufficient to cover the transaction amount. If so, the transaction is authorized (step 455). This type of transaction may be called a “seamless split-tender” transaction because funds from two different purses are used to cover the transaction amount but no user or merchant action is required at the POS in order to effect this split-tender transaction.

In addition to the prepaid funding of the multi-purse prepaid consumer discount card, some embodiments may include an associated credit or debit capability. If at step 450, the combined balance of the merchant category purse and the general-purpose purse are not sufficient to cover the transaction amount, the system may determine if an associated credit or debit facility exists (step 470). If so, the processing engine 192 may determine if the credit or debit facility is sufficient to cover the remaining transaction balance, that is, the portion of the transaction amount that exceeds the combined balance of the merchant category purse and general-purpose purse. The full amounts of these prepaid balances may be applied first towards the total transaction amount prior to funding the remainder with a credit or debit facility. When the credit or debit facility is sufficient to cover the remaining transaction balance (step 472, Yes), the transaction is authorized (step 455). This transaction may also be a “seamless split-tender” transaction since no user or merchant action is required at the POS at the time of the transaction.

Referring back to steps 470 and 472, if no credit or debit facility exists for this account or if the credit limit or debit account balance is insufficient to cover the remaining transaction balance (after the combined balance of the merchant category purse and general-purpose purse have been applied to the total transaction amount), then, the processing engine 190 may determine whether a standard split-tender transaction is supported by the merchant POS 115 (step 475). In this scenario, the prepaid balances of the multi-purse prepaid consumer discount card and any credit or debit facility are insufficient to cover the total transaction amount. If the merchant POS supports standard split-tender transactions, a split-tender transaction may be authorized but only up to the amount equal to the combined balance of the merchant category purse and the general-purpose purse plus whatever contribution is available from any credit or debit facility (step 480). The user 100 may provide some other payment method at the merchant POS 115 in order to complete the entire transaction.

In a case where a transaction has been authorized (e.g., steps 440, 455, or 480), the processing engine 190 may update the appropriate purse balances in the authorization tables 192 (step 485).

Referring back to step 475, if the merchant POS 115 does not support split-tender transactions, the transaction is declined (step 490).

Referring back to step 425, if the transaction has been initiated at a merchant that is not a program partner, the processing engine 190 may look up the current balance of the general-purpose purse in the authorization tables 192 (step 460). In one embodiment, prepaid funds allocated to one of the merchant category purses cannot be applied since the merchant is not a program partner but funds from the general-purpose purse may still be used to cover the transaction. At step 465, a determination may be made as to whether the general-purpose purse balance is sufficient to cover the transaction amount. If so, the transaction is authorized (step 440). If not, the system determines whether the user account has a credit or debit facility (step 470). From this point, the description of the process flow may be the same as described above. If a credit or debit facility with sufficient funds exists to cover any remaining transaction balance above the amount covered by the general-purpose purse, then a “seamless split-tender” transaction may be authorized in step 455. If no credit or debit facility exists or the balance of such is insufficient but the merchant POS supports standard split-tender transactions, then a split-tender transaction may be authorized for partial payment of the transaction in step 480. If neither of these scenarios is present, then the transaction may be declined in step 490.

FIG. 6 is a detailed process flow diagram depicting an exemplary method 265 for settling transactions with the multi-purpose prepaid consumer discount card. In certain embodiments, the settlement process may consist of two phases: a standard settlement process through the association network 135 involving the merchant's bank 132 and the issuing bank 155 as well as a second phase between the program manager 120 and merchant 118 where the merchant transfers a rebate to the program manager in an amount equal to the negotiated discount on the total applicable transaction volume with that merchant.

At step 500, the processing engine 190 may receive periodic settlement requests (e.g. daily, weekly) from each merchant 118. These settlement requests may use association network systems and processes, flowing from the merchant's bank 132 (i.e. “acquiring bank”) through the association network 135 to the payment processor 140 and back to the issuing bank 155. At step 505, the settlement requests may trigger a settlement process involving the payment processor 140, the issuing bank 155, the merchant's bank 132, and the association network 135. All authorized transactions may be settled for the full transaction amounts employing existing processes and systems. In another embodiment, no modification to these existing settlement processes is required.

At the completion of step 505, the merchant 118 may have been paid in full for all transactions in the settlement period. However, the merchant may have negotiated a discount rate with the program manager 120 that applies to all transaction volume paid by a user's prepaid merchant category purse and/or general-purpose purse. To effect a funds transfer from merchant to program manager that accounts for this negotiated discount, a secondary phase of the settlement process may be employed.

At step 510, the settlement engine 170 may access the merchant tables 180 where negotiated discount information is stored for merchant partners. In step 515, the settlement engine 170 may determine whether a settlement request is from a merchant that is part of the program and has a negotiated discount rate with the program manager 120. If not, the settlement process may be complete and the process 265 may end at 280.

If the settlement request is for a merchant partner (step 515, Yes), the settlement engine 170 calculates the merchant discount rebate by multiplying the negotiated discount rate for that merchant by the applicable transaction dollar volume for that merchant (step 520). An exemplary embodiment of this method 265 may define the applicable transaction dollar volume subject to the negotiated discount as that amount funded via the prepaid merchant category purse and/or general-purpose purse during the settlement period. Another embodiment may define the applicable transaction dollar volume as only those sales deemed incremental to the merchant's existing business. A method for determining incremental sales may be individually defined and negotiated between the program manager 120 and the merchant partner 118.

In step 525, the program manager 120 may initiate a request to merchant partner 118 for the rebate payment for that settlement period (e.g. daily, weekly). The specific format of the rebate request may be flexible and may be customized between the program manager 120 and merchant partner 118 to best suit that partner's internal systems and processes. In step 530, the merchant discount rebate funds may be transferred from the merchant's bank 132 to the program manager 120 where some portion of those funds may be allocated by the program manager 120 back to the prepaid discount funds pool.

FIG. 7 depicts exemplary database tables that may be employed consistent with embodiments of the present invention. For example, the tables may include a user table 175. The user table 175 may includes user profile information, such as identification, financial information, and preferences, as well as dynamic user information such as purse and/or points balances. The tables may also include merchant tables 180, which may include baseline and/or negotiated discount rates. The tables may also include an authorization table 192, which may include user information (e.g., account numbers, expiration dates, purse balances, links to banks or credit providers, etc.) and merchant information (e.g., merchant IDs, categories, etc.). Additionally, the tables may include a transaction table 195, which may include transaction information (e.g., account information, transaction amounts, date, account numbers, merchant identifiers, etc.).

While the figures depict systems and methods having particular locations or orders, embodiments consistent with this disclosure may be practiced using different arrangements of the components and/or steps. For example, the components described herein may be combined or further separated without departing from the scope of this disclosure. Indeed, one of ordinary skill in the art would understand that there are additional embodiments that are supported by and consistent with this disclosure that are not described herein. The scope of this application should be governed by the claims, not any particular embodiment disclosed herein.

What is claimed is:

1. A computer-implemented method for providing a prepaid multi-purse consumer discount card to a user, the method comprising:
loading, by a load engine, a set of subaccounts corresponding to a single user account with prepaid user-provided funds and non-user-provided prepaid discount funds, one or more of the subaccounts being associated with one or more merchants;
receiving, by a processing platform, a data element comprising transaction data associated with a transaction for the user, the transaction data comprising a transaction amount, discount card data, and merchant identification data;
determining, by a processing engine, whether the transaction is approved by comparing the transaction data to information stored in an authorization table;
when it is determined that the transaction is approved, sending an approval message to the merchant of the one or more merchants that is associated with that transaction that allows the user to obtain a discount on the transaction by using the user-provided funds to satisfy a first portion of the transaction; and
settling, by a settlement engine, a second portion of the transaction with the merchant based on the negotiated prepaid discount on an applicable transaction volume.

2. The method of claim 1, wherein loading the subaccounts with user-provided funds is user-initiated.

3. The method of claim 1, wherein loading the subaccounts with user-provided funds is automatically triggered based on purse balances, time/date schedules, or other automation.

4. The method of claim 1, further comprising using credit or debit facilities in conjunction with the multi-purse prepaid consumer discount card to fund the transaction.

5. The method of claim 1, wherein the transaction is approved based on combining purse balances and credit or debit facilities to fund a full transaction amount without user intervention at a merchant POS after initial presentment of the card or account number.

6. The method of claim 1, wherein the settlement process is implemented without modification to existing association network systems and processes.

7. The method of claim 1, wherein that applicable transaction volume is negotiated with each merchant and is based on a) a total transaction volume, b) a prepaid transaction volume, or c) an incremental sales transaction volume.

8. The method of claim 1, wherein the method is implemented without modification to existing merchant point-of-sale systems and processes such that the user is able to employ the card for a transaction at a merchant POS in a typical, accustomed fashion.

9. The method of claim 1, wherein obtaining the discount comprises applying funds to a prepaid discount funds pool and then disaggregating the funds pool to be distributed back to each user and applied to each user's purse balances.

10. A non-transitory computer-readable medium storing a set of instructions that, when executed by a processor, perform a method for providing a prepaid multi-purse consumer discount card, the method comprising:
loading a set of subaccounts corresponding to a single user account with prepaid user-provided funds and non-user-provided prepaid discount funds, one or more of the subaccounts being associated with one or more merchants;
receiving a data element comprising transaction data associated with a transaction for the user, the transaction data comprising a transaction amount, discount card data, and merchant identification data;
determining whether the transaction is approved by comparing the transaction data to information stored in an authorization table;
when it is determined that the transaction is approved, sending an approval message to the merchant of the one or more merchants that is associated with that transaction that allows the user to obtain a discount on the transaction by using the user-provided funds to satisfy a first portion of the transaction; and
settling a second portion of the transaction with the merchant based on the negotiated prepaid discount on an applicable transaction volume.

11. The medium of claim 10, wherein loading the subaccounts with user-provided funds is user-initiated.

12. The medium of claim 10, wherein loading the subaccounts with user-provided funds is automatically triggered based on purse balances, time/date schedules, or other automation.

13. The medium of claim 10, the method further comprising using credit or debit facilities in conjunction with the multi-purse prepaid consumer discount card to fund the transaction.

14. The medium of claim 10, wherein the transaction is approved based on combining purse balances and credit or debit facilities to fund a full transaction amount without user intervention at a merchant POS after initial presentment of the card or account number.

15. The medium of claim 10, wherein the settlement process is implemented without modification to existing association network systems and processes.

16. The medium of claim 10, wherein that applicable transaction volume is negotiated with each merchant and is based on a) a total transaction volume, b) a prepaid transaction volume, or c) an incremental sales transaction volume.

17. The medium of claim 10, wherein obtaining the discount comprises applying funds to a prepaid discount funds pool and then disaggregating the funds pool to be distributed back to each user and applied to each user's purse balances.

18. A system for providing a prepaid multi-purse consumer discount card, they system comprising:
a computer-readable storage medium storing a set of instructions for performing a method, the method comprising:
loading a set of subaccounts corresponding to a single user account with prepaid user-provided funds and non-user-provided prepaid discount funds, one or more of the subaccounts being associated with one or more merchants;
receiving a data element comprising transaction data associated with a transaction for the user, the transaction data comprising a transaction amount, discount card data, and merchant identification data;
determining whether the transaction is approved by comparing the transaction data to information stored in an authorization table;
when it is determined that the transaction is approved, sending an approval message to the merchant of the one or more merchants that is associated with that transaction that allows the user to obtain a discount on the transaction by using the user-provided funds to satisfy a first portion of the transaction; and
settling a second portion of the transaction with the merchant based on the negotiated prepaid discount on an applicable transaction volume.

19. The system of claim 18, wherein loading the subaccounts with user-provided funds is user-initiated.

20. The system of claim 18, wherein loading the subaccounts with user-provided funds automatically triggered based on purse balances, time/date schedules, or other automation.
